(19) United States
(12) Patent Application Publication
(10) Pub. No.: US 2016/0253664 A1
(43) Pub. Date: Sep. 1, 2016

(54) ATTESTATION BY PROXY

(71) Applicant: Samsung Electronics Co., Ltd, Suwon-si (KR)

(72) Inventors: Ding Yuan, Sunnyvale, CA (US); Chung Huan Liu, Palo Alto, CA (US); Aneesh Nainamvalappil, Richardson, TX (US); Minseok Park, Richardson, TX (US)

(21) Appl. No.: 15/055,314

(22) Filed: Feb. 26, 2016

Related U.S. Application Data
(60) Provisional application No. 62/208,359, filed on Aug. 21, 2015.
(60) Provisional application No. 62/126,121, filed on Feb. 27, 2015.

(51) Int. Cl. G06Q 20/40; G06Q 20/24; G06Q 20/38; G06Q 20/34; H04L 29/06; G06Q 20/32

(52) U.S. Cl. CPC G06Q 20/401; H04L 63/0281; H04L 63/0272; H04L 63/0884; H04L 63/20; G06Q 20/3226; G06Q 20/3829; G06Q 20/34; G06Q 20/24; G06Q 2220/00

(57) ABSTRACT

An embodiment of this disclosure provides a method and electronic device for attestation by proxy, the method comprising retrieving, by the electronic device, secure device data of the electronic device; performing, by an electronic device, attestation with an attestation server using a proxy server, wherein a validation result of the device is generated based on the secure device data; and communicating payment information with an application server when the validation result is trusted.

### CROSS-REFERENCE TO RELATED APPLICATION(S) AND CLAIM OF PRIORITY

This application claims priority under 35 U.S.C. §119(e) to U.S. Provisional Patent Application No. 62/208,359 filed on Aug. 21, 2015 and U.S. Provisional Patent Application No. 62/126,121 filed on Feb. 27, 2015. The above-identified provisional patent applications are hereby incorporated by reference in its entirety.

### TECHNICAL FIELD

Embodiments of this disclosure relate generally to secure communications. More specifically, embodiments of this disclosure relate to attestation by proxy.

### BACKGROUND

Using consumer electronic device as a means of payment for a payment transaction is popular and convenient for consumers. However, when enrolling credit cards on electronic devices, the sensitive secrete credit card payment information artifacts (e.g., account numbers, tokens, keys, etc.) are exposed to attackers because these artifacts are exchanged between electronic device and the card network token service provider (TSP). Attestation is the process where a device provides device measurement data signed with a trusted key. Device measurement data from the device is reliable for a short period of time after a nonce creation as the device can be compromised.

### SUMMARY

Embodiments of this disclosure provide examples of attestation by proxy.

A first embodiment of this disclosure provides a method for attestation by proxy. The method includes retrieving, by the electronic device, secure device data of the electronic device. The method also includes performing, by an electronic device, attestation with an attestation server using a proxy server. A validation result of the device is generated based on the secure device data. The method also includes communicating payment information with an application server when the validation result is trusted.

A second embodiment of this disclosure provides an electronic device for performing attestation by proxy. The electronic device comprises at least one processor configured to retrieve, by the electronic device, secure device data of the electronic device. The at least one processor is also configured to perform attestation with an attestation server using a proxy server. A validation result of the electronic device is generated based on the secure device data. The at least one processor is also configured to communicate payment information with an application server when the validation result is trusted.

A third embodiment of this disclosure provides a non-transitory computer readable medium containing computer readable program code that, when executed, causes at least one processing device of a mobile device to retrieve, by the electronic device, secure device data of the electronic device. The computer readable program code also causes the at least one processing device to perform attestation with an attestation server using a proxy server. A validation result of the electronic device is generated based on the secure device data. The computer readable program code also causes the at least one processing device to communicate payment information with an application server us when the validation result is trusted.

Other technical features may be readily apparent to one skilled in the art from the following figures, descriptions, and claims.

The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example computing system according to this disclosure;

FIGS. 2 and 3 illustrate example devices in a computing system according to this disclosure;

FIG. 4 illustrates a flow diagram of an attestation by proxy operation according to various embodiments;

FIG. 5 illustrates an example system for attestation by proxy according to this disclosure;

FIG. 6 illustrates a flow diagram of a token use operation based on electronic device attestation in accordance with various embodiments of the present disclosure;

FIG. 7 illustrates a flow diagram of a token use operation based on electronic device attestation in an electronic device according to various embodiments;

FIG. 8 illustrates a flow diagram of a token update operation based on token attestation in an electronic device according to various embodiments;

FIG. 9 illustrates a process for attestation by an electronic device in accordance with various embodiments of the present disclosure; and

FIG. 10 illustrates a process for attestation by proxy server in accordance with various embodiments of the present disclosure.

### DETAILED DESCRIPTION

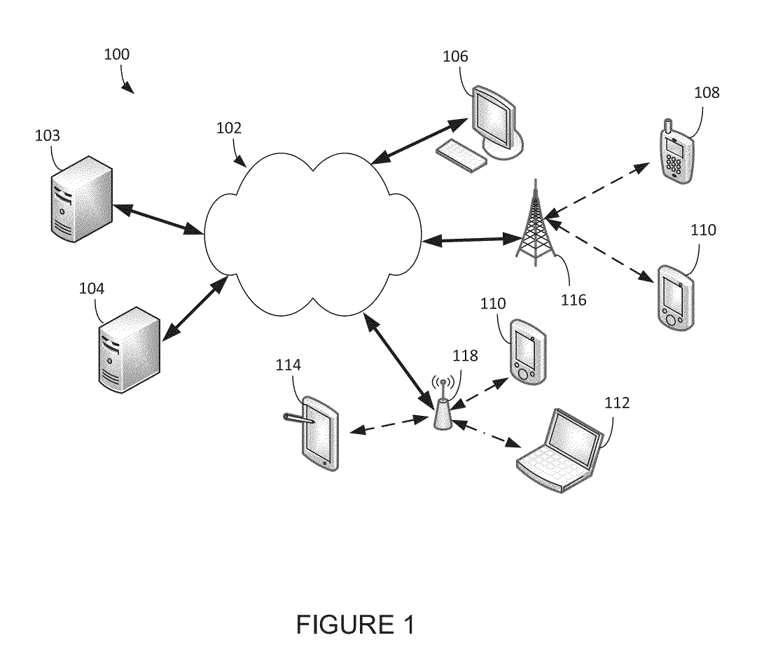

FIGS. 1 through 10, discussed below, and the various embodiments used to describe the principles of the present invention in this patent document are by way of illustration only and should not be construed in any way to limit the scope of the disclosure. Those skilled in the art will understand that the principles of this disclosure may be implemented in any suitably arranged device or system.

FIG. 1 illustrates an example computing system 100 according to this disclosure. The embodiment of the computing system 100 shown in FIG. 1 is for illustration only. Other embodiments of the computing system 100 could be used without departing from the scope of this disclosure.

As shown in FIG. 1, the system 100 includes a network 102, which facilitates communication between various components in the system 100. For example, the network 102 may communicate Internet Protocol (IP) packets, frame relay frames, Asynchronous Transfer Mode (ATM) cells, or other information between network addresses. The network 102 may include one or more local area networks (LANs), metropolitan area networks (MANs), wide area networks (WANs), all or a portion of a global network such as the Internet, or any other communication system or systems at one or more locations.

The network 102 facilitates communications between various servers 103 and 104 and various client devices 106-114. Each server 104 includes any suitable computing or processing device that can provide computing services for one or more client devices. Each server 104 could, for example, include one or more processing devices, one or more memories storing instructions and data, and one or more network interfaces facilitating communication over the network 102.

Each client device 106-114 represents any suitable computing or processing device that interacts with at least one server or other computing device(s) over the network 102. In this example, the client devices 106-114 include a desktop computer 106, a mobile telephone or smartphone 108, a personal digital assistant (PDA) 110, a laptop computer 112, and a tablet computer 114. However, any other or additional client devices could be used in the computing system 100.

In this example, some client devices 108-114 communicate indirectly with the network 102. For example, the client devices 108-110 communicate via one or more base stations 116, such as cellular base stations or eNodeBs. Also, the client devices 112-114 communicate via one or more wireless access points 118, such as IEEE 802.11 wireless access points. Note that these are for illustration only and that each client device could communicate directly with the network 102 or indirectly with the network 102 via any suitable intermediate device(s) or network(s).

As described in more detail below, the servers 103 or 104 represent servers associated with a manufacturer of one or more of the client devices, CA servers, financial servers, or token service provider (TSP) servers that participate in enabling trust-zone-based end-to-end security.

Although FIG. 1 illustrates one example of a computing system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

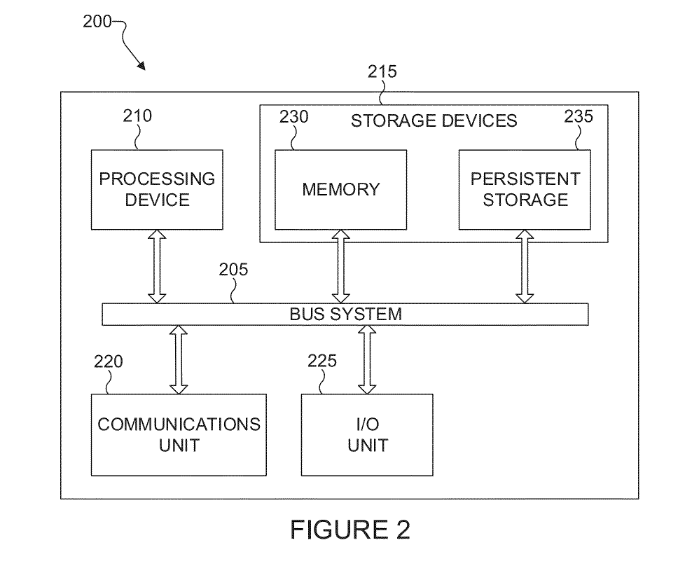

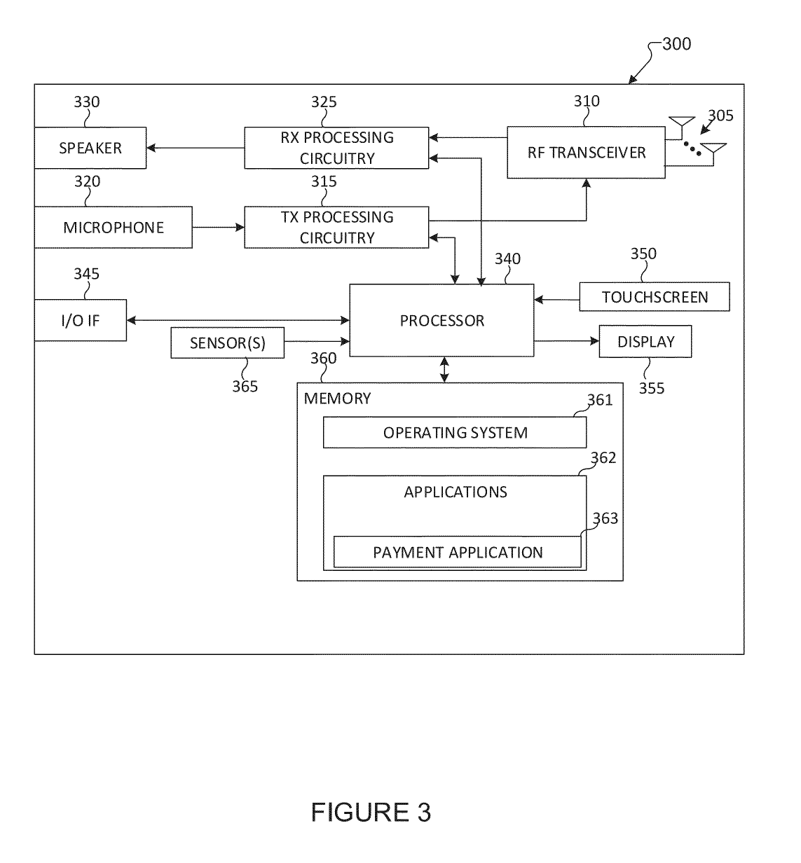

FIGS. 2 and 3 illustrate example devices in a computing system according to this disclosure. In particular, FIG. 2 illustrates an example server 200, and FIG. 3 illustrates an example client device 300. The server 200 could represent the servers 103 or 104 in FIG. 1, and the client device 300 could represent one or more of the client devices 106-114 in FIG. 1.

As shown in FIG. 2, the server 200 includes a bus system 205, which supports communication between at least one processing device 210, at least one storage device 215, at least one communications unit 220, and at least one input/output (I/O) unit 225.

The processing device 210 executes instructions that may be loaded into a memory 230. The processing device 210 may include any suitable number(s) and type(s) of processors or other devices in any suitable arrangement. Example types of processing devices 210 include microprocessors, microcontrollers, digital signal processors, field programmable gate arrays, application specific integrated circuits, and discreet circuitry.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random access memory or any other suitable volatile or non-volatile storage device(s). The persistent storage 235 may contain one or more components or devices supporting longer-term storage of data, such as a ready only memory, hard drive, Flash memory, or optical disc.

The communications unit 220 supports communications with other systems or devices. For example, the communications unit 220 could include a network interface card or a wireless transceiver facilitating communications over the network 102. The communications unit 220 may support communications through any suitable physical or wireless communication link(s).

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

Note that while FIG. 2 is described as representing the server 104 of FIG. 1, the same or similar structure could be used in one or more of the client devices 106-114. For example, a laptop or desktop computer could have the same or similar structure as that shown in FIG. 2.

FIG. 3 illustrates an example electronic device 300 according to various embodiments of the present disclosure. The embodiment of the electronic device 300 illustrated in FIG. 3 is for illustration only, and the client devices 108-114 of FIG. 1 could have the same or similar configuration. However, electronic devices come in a wide variety of configurations, and FIG. 3 does not limit the scope of this disclosure to any particular implementation of an electronic device.

As shown in FIG. 3, the electronic device 300 includes antenna(s) 305, a radio frequency (RF) transceiver 310, transmit (TX) processing circuitry 315, a microphone 320, and receive (RX) processing circuitry 325. The electronic device 300 also includes a speaker 330, a processor 340, an input/output (I/O) interface (IF) 345, a touchscreen 350, a display 355, a memory 360, and one or more sensors 365. The memory 360 includes an operating system (OS) 361 and one or more applications 362.

The RF transceiver 310 receives, from the antenna 305, an incoming RF signal transmitted by an eNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors and execute the OS program 361 stored in the memory 360 in order to control the overall operation of the electronic device 300. In some embodiments, the processor 340 includes at least one microprocessor or microcontroller.

The processor 340 is also capable of executing other processes and programs resident in the memory 360, such as operations that receive, store, and timely instruct the display of videos for screen burn-in prevention and reduction management. The processor 340 can move data into or out of the memory 360 as required by an executing process. In some embodiments, the processor 340 is configured to execute a plurality of applications 362, such as a payment application 363 for making secure payments using a financial account.

The processor 340 can operate the plurality of applications 362 based on the OS program 361. The processor 340 is also coupled to the I/O interface 345, which provides electronic device 300 with the ability to connect to other devices such as laptop computers and handheld computers. The I/O interface 345 is the communication path between these accessories and the processor 340. For example, the I/O interface 345 may include a near field communication (NFC) module for near field communication with, for example, a payment device to process a payment transaction.

The processor 340 is also coupled to the touchscreen 350 and the display 355. The operator of the electronic device 300 can use the touchscreen 350 to enter data into the electronic device 300. The display 355 may be a liquid crystal display, a light-emitting diode (LED) display, an optical LED (OLED), an active matrix OLED (AMOLED), or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Electronic device 300 further includes one or more sensor(s) 365 that can meter a physical quantity or detect an activation state of the electronic device 300 and convert metered or detected information into an electrical signal. For example, sensor 365 may include one or more buttons for touch input, a camera, a gesture sensor, a gyroscope or gyro sensor, an air pressure sensor, a magnetic sensor or magnetometer, an acceleration sensor or accelerometer, a grip sensor, a proximity sensor, a color sensor 365 (e.g., a Red Green Blue (RGB) sensor), a bio-physical sensor, a temperature/humidity sensor, an illumination sensor 365, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, etc. The sensor(s) 365 can further include a control circuit for controlling at least one of the sensors included therein. Any of these sensor(s) 365 may be located within the electronic device 300.

Although FIGS. 2 and 3 illustrate examples of devices in a communication system, various changes may be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the electronic device 300 configured as a mobile telephone or smartphone, electronic devices could be configured to operate as other types of mobile or stationary devices. In addition, as with computing and communication networks, client devices and servers can come in a wide variety of configurations, and FIGS. 2 and 3 do not limit this disclosure to any particular electronic devices.

Various embodiments of the present disclosure provide methods and systems ensure the payment artifacts can only be decrypted in a Trusted Execution Environment (TEE) of the electronic device 300 or by the Token Service Provider (TSP), creating end-to-end security, irrespective of any intermediate platforms the information has to traverse, such as the regular operating system of the electronic device, the Internet, and any servers that handle messages for TSP. In order to protect the secrecy of credit card payment artifacts, such as account numbers, tokens, and keys, one or more precautions may be taken. For example, in some embodiments, an encryption method is implemented to ensure the payment artifacts can only be decrypted in the TEE of the electronic device 300 or by the card network TSP, which creates end-to-end security.

One or more embodiments of this disclosure recognizes and takes into account that attestation used by SAMSUNG KNOX™ helps protect enterprise apps and data from unauthorized access by creating a virtual container within a device. Before the container is created, a Mobile Device Management (MDM) server must verify the device security status to identify whether the device is secure in order to create the container. Attestation can be used to verify the device's security status. Attestation is the process where a device provides device measurement data signed with a trusted key available only in ARM® Trust Zone®. Measurement data from the device is reliable for a short period of time after the nonce creation as the device can be compromised.

One or more embodiments of this disclosure recognizes and takes into account that to use remote attestation, an application server is normally required to perform time-consuming customizations and modifications to its communication protocols, including changes to the server side and device side components. The mechanism described in this disclosure of attestation by proxy allows an application server to gain the benefits of remote attestation without modifying server code or its device side components.

One or more embodiments provides implementing this attestation by proxy mechanism as part of a token requester server, which acts as the “proxy” performing remote attestation of the device on behalf of the application server that is the token service provider of the card network, and the trusted application of a bank card network.

One or more embodiments provide implementing this attestation by proxy mechanism by using the attestation proxy server as a VPN server, which will help avoid the application server to talk to attestation server every time. In this example, the entire configuration related to attestation is done on the VPN server. The entire configuration of the attestation agent, which works accordingly to the application server, can be configured on the VPN server. In other embodiments, only some of the configuration is performed on the VPN server. The configuration can include any of the steps or operations performed during the attestation process. Similarly, there is also a VPN server for the device side (also referred to herein as the VPN client). Due to the VPN server performing many or all of the operations, the device application will now use a reduced amount of processing.

One or more embodiments provide implementing this attestation by proxy mechanism by using in cooperation with devices that control people's vehicle, electronic equipment and home appliances in the concept of Internet of Things (IOT). In this example, since a mobile phone would serve as the core of IOT in controlling other equipment, the device security is very important; many application servers may attest the device first before processing through any request. One or more embodiments provide a proxy server to do all the attestation of the device instead, so all application servers can just enjoy the benefits of getting the attestation result from proxy server.

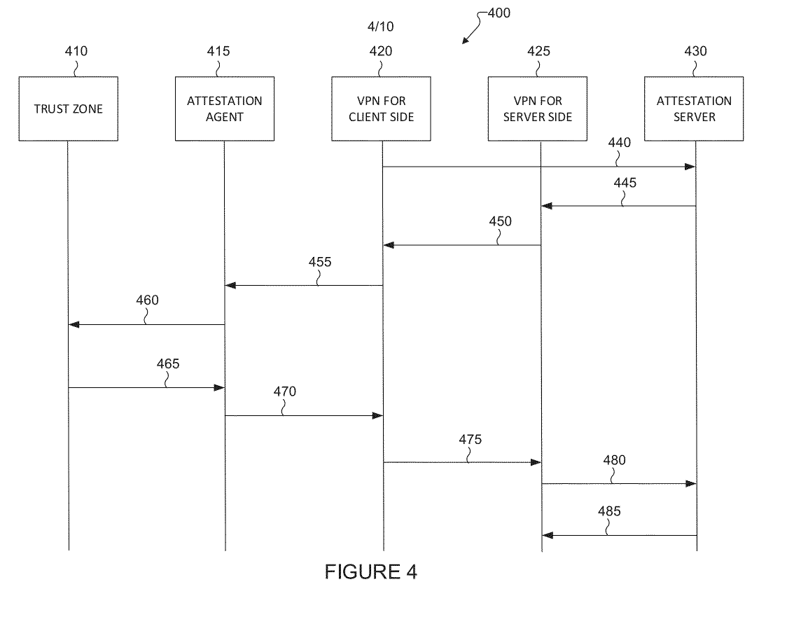

FIG. 4 illustrates a flow diagram 400 of an attestation by proxy operation according to various embodiments. The embodiment of the flow diagram 400 shown in FIG. 4 is for illustration only. Other embodiments of the flow diagram 400 could be used without departing from the scope of this disclosure.

In FIG. 4, a system includes electronic device 505 with trust zone 410, attestation agent 415, and virtual private network (VPN) for client side 420. The system also includes attestation server 430, VPN for server side 425, and application server 535. Attestation server 430 and VPN server 425 could be examples of servers 103 and 104 in FIG. 1. VPN for server side 425 could be part of attestation server 430. The attestation server 430 can produce validation result 550. The validation result can be used to validate the security of electronic device 505.

In an embodiment of this disclosure, the attestation by proxy system uses a VPN server 425 to talk to the attestation server 430. An application server will receive the result from VPN server 425 because the entire configuration is done at VPN server 425. Accordingly, the client side on device will also use a VPN client 420 to respond to the attestation request and provide required information.

For example, when MDM server needs to attest the mobile device, in normal attestation process, it will be configured to connect to the cloud based attestation server, and also any other server which needs to do attestation process like token requestor server to remember attestation server information. But in Attestation by Proxy procedure, all these servers just wait for VPN server to do all the work for them. On the other hand, normally device needs to install specific API like MDM api which will also be avoided in Attestation by Proxy procedure.

In FIG. 4, a VPN client 420 establishes secure and authenticated connection with the VPN server 425. The VPN client 420 requests nonce from the attestation server 430 (440). The nonce is generated by the attestation server 430 and stored with a timestamp, and sent to the VPN server 425 (445). The VPN server 425 starts the attestation process by sending the nonce to the VPN client 420 (450). The VPN client 420 passes the nonce to the attestation agent 415 (455). The nonce is used by the attestation agent 415 to request a measurement from the trust zone 410 (460). The trust zone 410 returns a blob to the attestation agent 415 (465). The blob contains the nonce, measurements, device ID, signature, and certificate chain. The measurements can be cryptographic measurements of a boot loader and kernel of the electronic device 505. The blob is passed to the attestation agent 415 to the VPN client 420 (470) and then to the VPN server 425 (475). The VPN server 425 asks the attestation server 430 to parse the blob, and perform signature and certificate checks (480). The attestation server 430 sends the measurement results and verdict to the VPN server 425 (485). The VPN server 725 checks the nonce, timestamps and verdict that are returned by the attestation server 430 and perform necessary format transformation before sending the verdict to the application server. Once the application server trusts the electronic device, accept the coming request and work as expected.

One or more embodiments of this disclosure provides that attestation by proxy allows learning a devices security status, helping vendors know whether a device contains original factory images, checking if anything has changed on a device, and if so, how it could affect a security container. Attestation can be performed when an integrity check of a device is required, before a security container is created, when MDM vendors trigger the attestation process periodically as needed, when a device enrolls in a payment application, such as SAMSUNG PAY™, and needs to talk to a token requestor server, and anytime when a server needs to know the security status of a device.

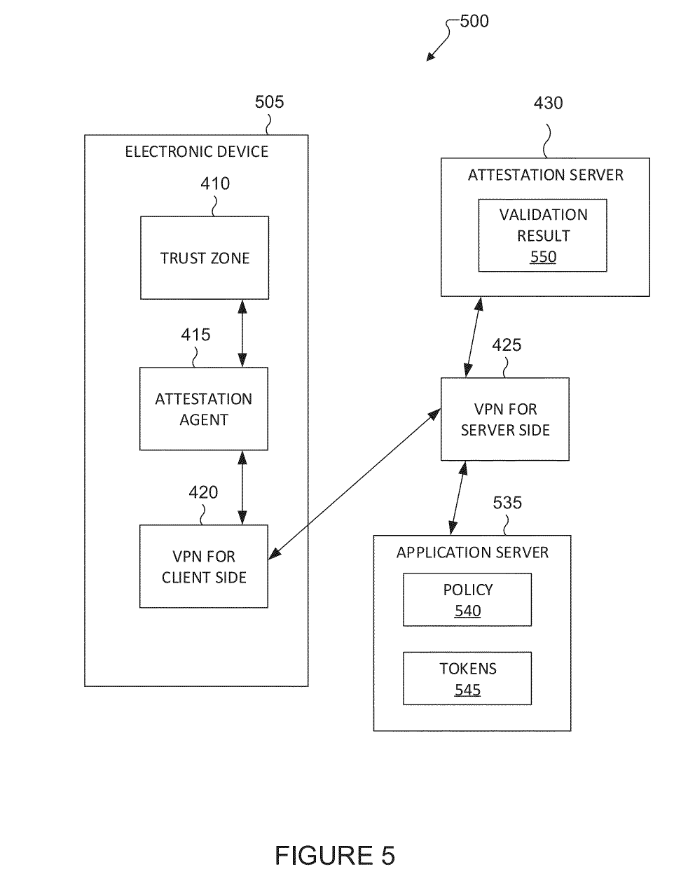

FIG. 5 illustrates an example system 500 for attestation by proxy according to this disclosure. The embodiment of the system 500 shown in FIG. 5 is for illustration only. Other embodiments of the system 500 could be used without departing from the scope of this disclosure. System 500 can be one example of computing system 100 in FIG. 1.

In FIG. 5, system 500 includes electronic device 505 with trust zone 410, attestation agent 415, and virtual private network (VPN) for client side 420. System 400 also includes attestation server 430, VPN for server side 425, and application server 435. Attestation server 430 and application server 535 could be examples of servers 103 and 104 in FIG. 1. VPN for server side 425 could be included as part of attestation server 430 or application server 535.

The electronic device 505 can be one example of client devices 106-114 in FIG. 1. The electronic device 505 includes the trust zone 410 and the attestation agent 415. The trust zone 410 can be a container that is virtual and secure. The trust zone 410 is configured to protect measurement data signed with a trusted key. This trusted key can be used to form a secure device data for use with the attestation agent 415. The secure device data may be, in one example, a binary large object (BLOB).

The VPN 425 and 420 are used by electronic device 505 to communicate with attestation server 430 and application server 535. The application server 535 can include a policy 540 and tokens 545. The tokens 545 can be used by electronic device 505 to conduct electronic payments. Policy 540 may include information, requirement and/or criteria (e.g., validation logic, attestation rules, etc.) used to complete attestation according to certain card network or payment service provider. Each card network or payment service provide may impose distinctive policy. Policy 540 may further specify the data format and/or data content of the attestation result that is acceptable by the card network or payment service provider.

In one embodiment, the system 500 allows payment networks such as VISA™, MASTER CARD™, and AMERICAN EXPRESS™ to enjoy the benefits of remote attestation without having to make any changes to their server or require any special device components for electronic devices. The embodiment provides the payment server 610 acting as an attestation proxy, and performing attestation on behalf of the card network.

In the embodiment implemented through a VPN server, the attestation by proxy is actually using a VPN server to talk to the attestation server. The application server can receive the result from VPN server when the entire configuration is done at VPN server. Accordingly, the client server on device can also use a VPN server to respond to the attestation request and provide required information. An aspect of this disclosure allows an application provider (such as a financial institution) to take advantage of attestation without having to make modifications to server or device components of its software.

Originally, attestation is used to protect enterprise apps and data from unauthorized access by creating a virtual security container within a device. Before the container is created, a Mobile Device Management (MDM) server must verify the device security status to identify whether the device is secure in order to create the container. Attestation can be used to verify the device's security status. Attestation is the process where a device provides device measurement data signed with a trusted key available only in the secure container (i.e., trust zone). Measurement data from the device is reliable for a short period of time after the nonce creation as the device can be compromised.

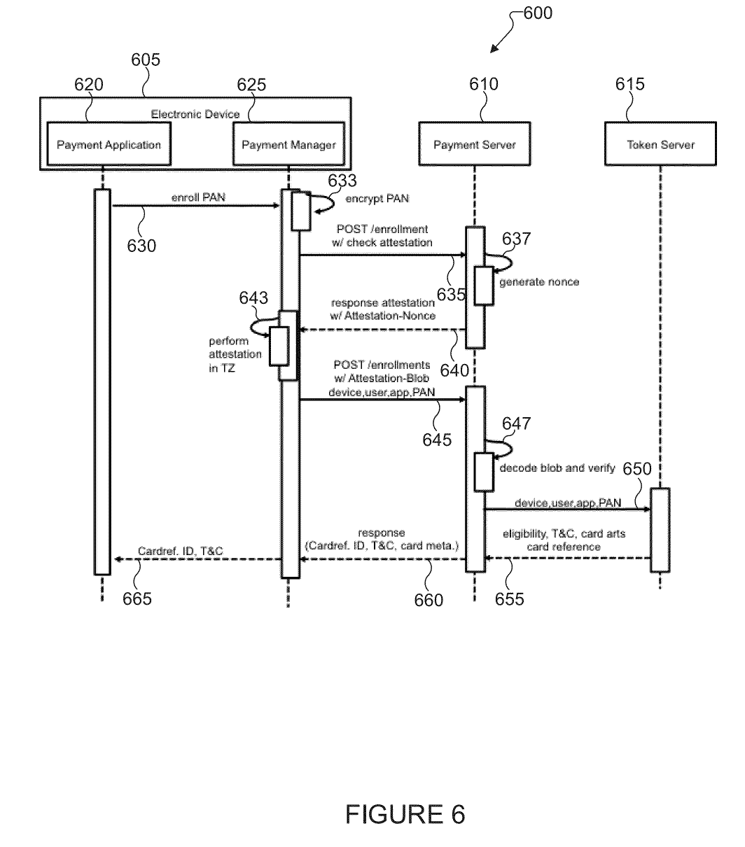

FIG. 6 illustrates a flow diagram 600 of a token use operation based on electronic device attestation by proxy in accordance with various embodiments of the present disclosure. The embodiment of the flow diagram 600 shown in FIG. 6 is for illustration only. Other embodiments of the flow diagram 600 could be used without departing from the scope of this disclosure.

In FIG. 6, the solid line may include a request (e.g., request or call) command and the dotted line may include a response (e.g., response or return) command. According to an embodiment, the payment system may include an electronic device 605, a payment server 610 (e.g., may include a payment service server and/or a token requester server), and a token server 615 (also referred to as a token service provider). The electronic device may include, for example, a payment application 620 and/or a payment manager 625. The token server 615 may issue or manage information (such as tokens) related to payment. The token server 615 may control the operation cycle of the token.

According to various embodiments, the electronic device 605 may store information that can be used for payment, using an external input or a sensor 365 (e.g., camera sensor or Optical Character Reader (OCR)) functionally connected to the electronic device 605. For example, the information that can be used for payment may include card information (e.g., PAN), a valid period, CVV, or a user name. In one embodiment, the electronic device 605 may execute an application (e.g., payment application 620) included in the electronic device 605 on the basis of an external input (e.g., user input). The electronic device 605 may store, in a payment application 620 included in the electronic device 605, information that can be used for payment through an external input (e.g., touch, double touch, long press, leftward/rightward movement after touch, gesture, or drag and stop) or a sensor functionally connected to the electronic device 605. The information that can be used for payment may include, for example, Primary Account Number (PAN). The PAN may include an account number associated with a Bank Identification Number (BIN) generated by a financial server.

According to various embodiments, the electronic device 605 may store information, which is associated with the payment application 620 and can be used for payment, in the electronic device 605 or the external device (e.g., server). For example, the electronic device 605 may store information, which can be used for payment corresponding to the payment application 620, in a memory (e.g., the memory 230 of FIG. 2 or memory 360 of FIG. 3) included in the electronic device 605 or in an external device (e.g., any of client devices 106-114, or the server 104 of FIG. 1).

According to various embodiments, the electronic device 605 may provide an interface for the information that can be used for payment. The interface may include the information that can be used for payment, for example, letters for the PAN, a picture, an icon, a notification, or an indicator.

According to various embodiments, the electronic device 605 may register a PAN using the payment application 620. For example, the electronic device 605 may transfer the PAN to the payment application 620. According to an embodiment, the payment manager 625 may provide information related to the PAN, which has been input through a sensor functionally connected to the electronic device 605, to the user by transferring the PAN to the payment manager 625 (630).

According to various embodiments, the payment manager 625 may encrypt the PAN (633). For example, the payment manager 625 may encrypt the PAN using a key included in the security application in order to protect the PAN from the outside. Further, for example, information received from the electronic device 605 or the external device (e.g., a server or financial server) may be used in the encryption.

According to various embodiments, the payment manager 625 may register an encrypted PAN in the payment server 610 (635). For example, the payment manager 625 may be functionally connected with the payment server 610 to transfer the encrypted PAN. The encrypted PAN may be transferred through a protection channel for protection against the outside. For example, the payment manager 625 may use a predetermined command (e.g., POST/enrollment) in registering the PAN in the payment server 610. Further, the payment server 610 may control the encrypted PAN through, for example, the token requester server included in the payment server 610. Hereinafter, the encrypted PAN may be simply referred to as PAN.

According to various embodiments, POST/enrollment, which is a predetermined command, may be used when the payment manager 625 requests the payment server 610 to provide a signal for card registration. The parameter of POST/enrollment may include, for example, one parameter among type, entry, token requester ID, user ID, app ID, device ID, card reference ID, device name, device profile, device certificates for encryption and signing, device pair, payment instrument, and presentation mode. The card type may include, for example, a payment card name (e.g., payment account brand). The payment card name may include, for example, at least one of VISA™, MASTER CARD™, AMERICAN EXPRESS™, or DISCOVERY™. The entry may include, for example, a card entry method. The card entry method may include, for example, at least one of MANUAL, OCR, APP, or FILE. The device profile may include, for example, the type (e.g., ordinary electronic device 605 or wearable device) of the electronic device 605. The payment instrument may include, for example, payment information (e.g., PAN, valid period, or CVV). The presentation mode may include, for example, a payment method (e.g., MST or NFC) used for payment.

According to various embodiments, the POST/enrollment, which is the predetermined command, may include a command for checking whether the payment server 610 requires attestation of the electronic device 605, in order to attest the electronic device 605. For example, the payment server 610 may send a command with “Expect: 100-continue” request header, which is used in HyperText Transfer Protocol (HTTP), to the token server 615 to receive data (e.g., disposable random number) from the token server 615.

According to various embodiments, the payment server 610 may perform the attestation on the predetermined command received from the payment manager 625. For example, the payment server 610 may perform the attestation of the electronic device 605 or the payment manager 625 on the basis of the predetermined command or a condition designated to the payment server 610.

According to various embodiments, in the case of not performing the attestation, the payment server 610 may perform at least a part of the token issuance operations. According to various embodiments, in the case of performing the attestation, the payment server 610 may generate a disposable random number (e.g., nonce) (637). The disposable random number may be, for example, generated by the payment server 610 or received from an external device. Further, the disposable random number may include valid time or use time, for which the payment function is usable.

According to various embodiments, the payment server 610 may transfer, to the payment manager 625, an instruction to perform a function associated with the attestation (640). For example, in response to the predetermined command (e.g., POST/enrollment), the payment server 610 may transfer the instruction, using the disposable random number. For example, the payment server 610 may send a response including Attestation-Nonce, which is a disposable random number associated with the attestation, to the payment manager 625.

According to various embodiments, the payment manager 625 may perform the attestation in accordance with the response associated with the attestation received from the payment server 610 (643). The attestation may be performed in, for example, the trust zone, which is a security area of the electronic device 605. The trust zone may be included in, for example, the TEE.

According to various embodiments, the attestation may be performed using a unique electronic device key (e.g. key or LUK) included (stored) in the trust zone. The attestation may include an operation of checking the integrity of the electronic device 605 or an electronic device 605 performing the payment function. The key may be included in the electronic device 605 at the time of manufacturing (processing) the electronic device 605.

According to one embodiment, the attestation may be performed by another key made using the key. For example, based on the key, a TEE public key or a TEE private key may be made and used.

According to various embodiments, the key may be changed at the operation time point of, for example, the electronic device 605 or the electronic device 605. For example, when the electronic device 605 or the electronic device 605 is not normally booted, the key may be deleted, revised, or damaged. Further, when the key is used in the electronic device 605 or the electronic device 605 using a predetermined revised file (e.g., image), the key may be deleted, revised, or damaged. According to various embodiments, when there is a random access to the trust zone, for example, the TEE, from the outside, the key may be deleted, revised, or damaged.

According to various embodiments, when the electronic device 605 or the electronic device 605 is normally booted, information included in the key may be changed. For example, the key may be randomly changed, and may be generated to include new information whenever the electronic device 605 is booted.

According to various embodiments, the key may be included in the security module. For example, the key may be stored a security module distinguished from the trust zone. The security module may include, for example, a security area, and may be physically distinguished from an element (e.g., payment application 620) of the electronic device 605 or the electronic device 605. Further, the key may be identical or similar to, for example, a unique key corresponding to the security module.

According to various embodiments, the payment manager 625 may transfer the disposable random number received by the payment server 610 to the trust zone. The trust zone may perform the attestation using, for example, the disposable random number, and generate blob associated with the attestation.

According to various embodiments, the trust zone may generate the blob on the basis of the disposable random number, for example, the disposable random number having use time or valid time configured therefor, and the key. According to various embodiments, the payment manager 625 may receive a blob generated based on the disposable random number, from the trust zone.

According to various embodiments, the payment manager 625 may transfer the blob and/or the PAN to the payment server 610 (645). The payment manager 625 may use a predetermined command (e.g., POST/enrollments w/Attestation-Blob) for the transfer. The payment manager 625 may transfer, for example, the blob, the blob and the PAN, a device profile, a user ID, or an application ID to the payment server 610.

According to various embodiments, the payment server 610 may determine the validity of the OTP value or numerical value received from the payment manager 625 (647). For example, the payment server 610 may determine the validity, using the blob and the disposable random number generated by the payment server 610.

According to various embodiments, when the blob information is valid, the payment server 610 may transfer the device profile, user ID, and the application ID to the token server 615 (650). The device profile may include a device ID (e.g., International Mobile Equipment Identity (IMEI)) and/or payment means (e.g., Near Field Communication (NFC) and/or Magnetic Secure Transmission (MSC)). Further, the device profile may include an identifier (e.g., device ID) for identifying a device. The user ID may include, for example, a name of a user using the electronic device 605. The app ID may include, for example, an identifier of a payment application 620 (e.g. SAMSUNG WALLET™).

According to various embodiments, when the blob information is not valid, the payment server 610 may stop (interrupt) the attestation or card registration operation. According to various embodiments, when the blob information is not valid, the payment server 610 may transfer a result (e.g., attestation failure) of the attestation to the electronic device 605 (e.g., the payment manager 625) or another electronic device 605.

According to various embodiments, the token server 615 may generate a channel (e.g., session) between the payment server 610 and the token server 615 in response to the reception of the user information. The channel may encrypt information (e.g., data) transmitted or received through the channel, for example, using a common (public) key shared by the payment server 610 and the token server 615. According to various embodiments, the payment server 610 may transfer a PAN (e.g., an encrypted PAN) to the token server 615, using a channel generated between the payment server 610 and the token server 615.

According to various embodiments, the token server 615 may register the PAN received from the payment server 610. The registration process may include a procedure of checking, using at least one ID among the user ID, app ID, device ID, or card reference ID, whether token issuance is possible. For example, the token server 615 may perform a process of checking whether it is possible to issue a token for the card, using the card reference ID. According to another embodiment, a process of checking whether the device having been already registered, by a registered user, using a device ID and a user ID. According to one embodiment, the token server 615 may register the PAN received from the payment server 610 and transfer a response (e.g., card reference ID) to the registration to the payment server 610 (655). The response to the registration may include, for example, at least one of a card reference ID, a contract condition, card metadata, or issuer metadata.

According to various embodiments, the payment server 610 may transfer information received from the token server 615, for example, a response to the registration, to the payment manager 625 (660), and the payment manager 625 may transfer the information to the payment application 620. The response to the registration may include, for example, at least one of a card reference ID, a contract condition, card metadata, or issuer metadata.

According to various embodiments, at least a part of the response to the registration of PAN (e.g., POST/enrollment) may be information stored in the payment server 610 or the payment manager 625 and may be changed (e.g., generation, revision, or removal) according to a predetermined condition. According to various embodiments, the payment application 620 may output at least a part of the response to the registration received from the payment manager 625 to the outside, to the user. For example, the payment application 620 may display the contract conditions included in the response.

According to various embodiments, the information for performing the attestation may be stored in an external device. For example, in order to perform the attestation, the disposable random number, the blob, the key, the device profile, the user ID, the app ID, or the public (open) key may be stored inside or outside of the electronic device 605. The external device may include, for example, an attestation server.

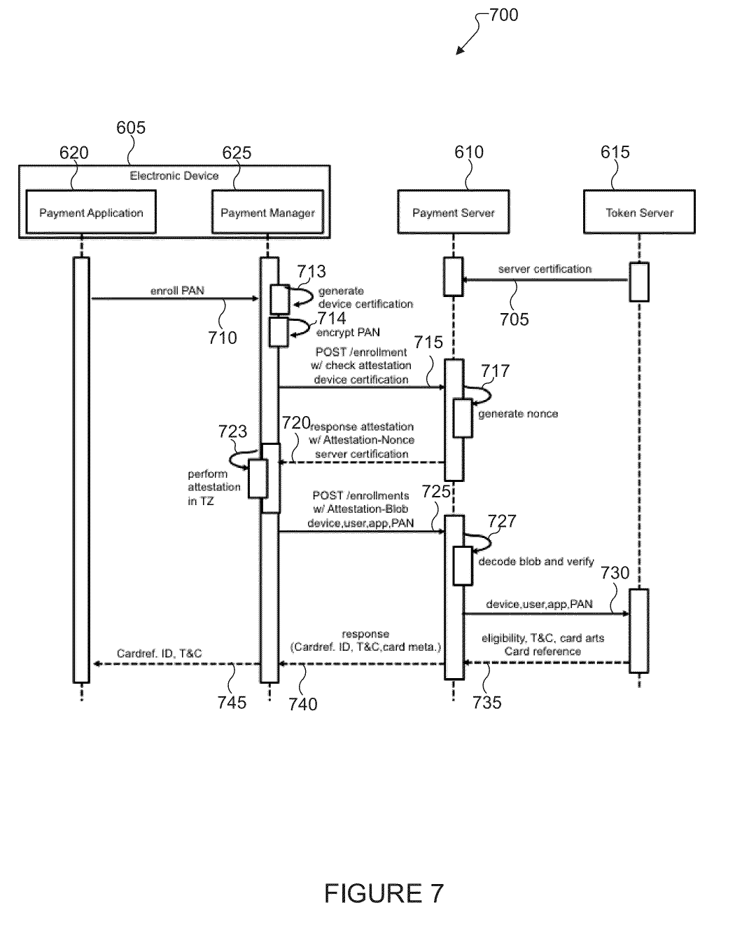

FIG. 7 illustrates a flow diagram 700 of a token use operation based on electronic device attestation in an electronic device 605 according to various embodiments. The embodiment of the flow diagram 700 shown in FIG. 7 is for illustration only. Other embodiments of the flow diagram 700 could be used without departing from the scope of this disclosure.

In FIG. 7, the solid line may include a request (e.g., request or call) command and the dotted line may include a response (e.g., response or return) command. According to an embodiment, the payment system may include an electronic device 605, a payment server 610, or a token server 615. The electronic device 605 may include, for example, a payment application 620 and/or a payment manager 625.

According to various embodiments, the token server 615 may transfer information associated with authentication (certification) to the payment server 610 (705). The authentication may include, for example, server authentication. The server authentication may include, for example, authentication using a Certificate Authority (CA).

According to various embodiments, the electronic device 605 may store information that can be used for payment, using an external input or a sensor 365 (e.g., camera sensor or Optical Character Reader (OCR)) functionally connected to the electronic device 605. For example, the information that can be used for payment may include card information (e.g., PAN), a valid period, CVV, or a user name. According to an embodiment, the electronic device 605 may execute an application (e.g., payment application 620) included in the electronic device 605 on the basis of an external input (e.g., user input). The electronic device 605 may store, in a payment application 620 included in the electronic device 605, information that can be used for payment through an external input (e.g., touch, double touch, long press, leftward/rightward movement after touch, gesture, or drag and stop) or a sensor functionally connected to the electronic device 605. The information that can be used for payment may include, for example, Primary Account Number (PAN). The PAN may include an account number associated with a Bank Identification Number (BIN) generated by a financial server.

According to various embodiments, the electronic device 605 may store information, which is associated with the payment application 620 and can be used for payment, in the electronic device 605 or the external device (e.g., server). For example, the electronic device 605 may store information, which can be used for payment corresponding to the payment application 620, in a memory (e.g., the memory 230 of FIG. 2 or memory 360 of FIG. 3) included in the electronic device 605 or in an external device (e.g., any of client devices 106-114, or the server 104 of FIG. 1).

According to various embodiments, the electronic device 605 may provide an interface for the information that can be used for payment. The interface may include the information that can be used for payment, for example, letters for the PAN, a picture, an icon, a notification, or an indicator.

According to various embodiments, the electronic device 605 may register a PAN using the payment application 620. For example, the electronic device 605 may transfer the PAN to the payment application 620. According to an embodiment, the payment manager 625 may provide information related to the PAN, which has been input through a sensor functionally connected to the electronic device 605, to the user by transferring the PAN to the payment manager 625 (710).

According to various embodiments, the payment manager 625 may encrypt the PAN (714). For example, the payment manager 625 may generate a device certification (713). The payment manager 625 may encrypt the PAN using a key included in the security application in order to protect the PAN from the outside (714). Further, for example, information received from the electronic device 605 or the external device (e.g., a server or financial server) may be used in the encryption.

According to various embodiments, the payment manager 625 may register an encrypted PAN in the payment server 610 (715). For example, the payment manager 625 may be functionally connected with the payment server 610 to transfer the encrypted PAN. The encrypted PAN may be transferred through a protection channel for protection against the outside. For example, the payment manager, 625 may use a predetermined command (e.g., POST/enrollment) in registering the PAN in the payment server 610. Further, the payment server 610 may control the encrypted PAN through, for example, the token requester server included in the payment server 610. Hereinafter, the encrypted PAN may be simply referred to as PAN.

According to various embodiments, POST/enrollment, which is a predetermined command, may be used when the payment manager 625 requests the payment server 610 to provide a signal for card registration. The parameter of POST/enrollment may include, for example, one parameter among type, entry, token requester ID, user ID, app ID, device ID, card reference ID, device name, device profile, device certificates for encryption and signing, device pair, payment instrument, or presentation mode. The card type may include, for example, a payment card name (e.g., payment account brand). The payment card name may include, for example, at least one of VISA™, MASTER CARD™, AMERICAN EXPRESS™, or DISCOVERY™. The entry may include, for example, a card entry method. The card entry method may include, for example, at least one of MANUAL, OCR, APP, or FILE. The device profile may include, for example, the type (e.g., ordinary electronic device 605 or wearable device) of the electronic device 605. The payment instrument may include, for example, payment information (e.g., PAN, valid period, or CVV). The presentation mode may include, for example, a payment method (e.g., MST or NFC) used for payment.

According to various embodiments, the POST/enrollment, which is the predetermined command, may include a command for checking whether the payment server 610 requires attestation of the electronic device 605, in order to attest the electronic device 605. For example, the payment server 610 may send a command with “Expect: 100-continue” request header, which is used in HyperText Transfer Protocol (HTTP), to the token server 615 to receive data (e.g., disposable random number) from the token server 615.

According to various embodiments, the payment server 610 may perform the attestation on the basis of a predetermined command received from the payment manager 625. For example, the payment server 610 may perform the attestation of the electronic device 605 or the payment manager 625 on the basis of the predetermined command or a condition designated to the payment server 610. According to various embodiments, in the case of not performing the attestation, the payment server 610 may perform at least a part of the token issuance operations.

According to various embodiments, in the case of not performing the attestation, the payment server 610 may generate a disposable random number (717). The disposable random number may be, for example, generated by the payment server 610 or received from an external device. Further, the disposable random number may include valid time or use time, for which the payment function is usable.

According to various embodiments, the payment server 610 may transfer, to the payment manager 625, an instruction to perform a function associated with the attestation (720). For example, in response to the predetermined command, the payment server 610 may transfer the instruction, using the disposable random number. For example, the payment server 610 may send a response including Attestation-Nonce, which is a disposable random number associated with the attestation, to the payment manager 625.

According to various embodiments, the payment manager 625 may perform the attestation in accordance with the response associated with the attestation received from the payment server 610 (723). The attestation may be performed in, for example, the trust zone, which is a security area of the electronic device 605. The trust zone may be included in, for example, the TEE.

According to various embodiments, the attestation may be performed using a key included (stored) in the trust zone. The attestation may include an operation of checking the integrity of the electronic device 605 or an electronic device 605 performing the payment function. The key may be included in the electronic device 605 at the time of manufacturing (processing) the electronic device 605. According to one embodiment, the attestation may be performed using another key made using the key described above. For example, based on the above key, a TEE public key or TEE private key may be made and used.

The notification associated with the call center method may include, for example, the electronic device 605 or the number of the electronic device 605. For example, when the electronic device 605 or the electronic device 605 is not normally booted, the key may be deleted, revised, or damaged. Further, when the key is used in the electronic device 605 or the electronic device 605 using a predetermined revised file (e.g., image), the key may be deleted, revised, or damaged. According to various embodiments, when there is a random access to the trust zone, for example, the TEE, from the outside, the key may be deleted, revised, or damaged. According to various embodiments, when the electronic device 605 or the electronic device 605 is normally booted, information included in the key may be changed. For example, the key may be randomly changed, and may be generated to include new information whenever the electronic device 605 is booted.

According to various embodiments, the key may be included in the security module. For example, the key may be stored a security module distinguished from the trust zone. The security module may include, for example, a security area, and may be physically distinguished from an element (e.g., payment application 620) of the electronic device 605 or the electronic device 605. Further, the key may be identical or similar to, for example, a unique key corresponding to the security module.

According to various embodiments, the payment manager 625 may transfer the disposable random number received by the payment server 610 to the trust zone. The trust zone may perform the attestation using, for example, the disposable random number, and generate blob associated with the attestation.

According to various embodiments, the trust zone may generate the blob on the basis of the disposable random number, for example, the disposable random number having use time or valid time configured therefor, and the key. According to various embodiments, the payment manager 625 may receive a blob generated based on the disposable random number, from the trust zone.

According to various embodiments, the payment manager 625 may transfer the blob and/or the PAN to the payment server 610 (725). The payment manager 625 may use a predetermined command (e.g., POST/enrollments w/Attestation-Blob) for the transfer. The payment manager 625 may transfer, for example, the blob, the blob and the PAN, a device profile, a user ID, or an application ID to the payment server 610.

According to various embodiments, the payment server 610 may determine the validity of the blob received from the payment manager 625 (727). For example, the payment server 610 may determine the validity, using the blob and the disposable random number generated by the payment server 610.

According to various embodiments, when the blob information is valid, the payment server 610 may transfer the device profile, user ID, and the application ID to the token server 615 (730). The device profile may include a device ID (e.g., International Mobile Equipment Identity (IMEI)) and/or payment means (e.g., Near Field Communication (NFC) and/or Magnetic Secure Transmission (MSC)). Further, the device profile may include an identifier (e.g., device ID) for identifying a device. The user ID may include, for example, a name of a user using the electronic device 605. The app ID may include, for example, an identifier of a payment application 620 (e.g. SAMSUNG WALLET™).

According to various embodiments, when the blob information is not valid, the payment server 610 may stop (interrupt) the attestation or card registration operation. According to various embodiments, when the blob information is not valid, the payment server 610 may transfer a result (e.g., attestation failure) of the attestation to the electronic device 605 (e.g., the payment manager 625) or another electronic device 605.

According to various embodiments, the token server 615 may generate a channel (e.g., session) between the payment server 610 and the token server 615 in response to reception of the user information. The channel may encrypt information (e.g., data) transmitted or received through the channel, for example, using a common (public) key shared by the payment server 610 and the token server 615. According to various embodiments, the payment server 610 may transfer a PAN (e.g., an encrypted PAN) to the token server 615, using a channel generated between the payment server 610 and the token server 615.

According to various embodiments, the token server 615 may register the PAN received from the payment server 610. The registration process may include a procedure of checking, using at least one ID among the user ID, app ID, device ID, and card reference ID, whether token issuance is possible. For example, the token server 615 may perform a process of checking whether it is possible to issue a token for the card, using the card reference ID. According to another embodiment, a process of checking, by a user having registered using a device ID and a user ID, whether the device having been already registered is right. According to one embodiment, the token server 615 may register the PAN received from the payment server 610 and transfer a response (e.g., card reference ID) to the registration to the payment server 610 (730). The response to the registration may include, for example, at least one of a card reference ID, a contract condition, card metadata, or issuer metadata.

According to various embodiments, the payment server 610 may transfer information received from the token server 615, for example, a response to the registration, to the payment manager 625 (740), and the payment manager 625 may transfer the information to the payment application 620 (745). The response to the registration may include, for example, at least one of a card reference ID, a contract condition, card metadata, or issuer metadata.

According to various embodiments, at least a part of the response to the registration of PAN (e.g., POST/enrollment) may be information stored in the payment server 610 or the payment manager 625 and may be changed (e.g., generation, revision, or removal) according to a predetermined condition.

According to various embodiments, the payment application 620 may output at least a part of the response to the registration received from the payment manager 625 to the outside, to the user. For example, the payment application 620 may provide a user with the contract conditions included in the response to the registration.

According to various embodiments, the information for performing the attestation may be stored in an external device. For example, the disposable random number, the blob, the key, the device profile, the user ID, the application ID, or the common (public) key, which are to be used for the attestation, may be stored in the electronic device 605 or outside of the electronic device 605. The external device may include, for example, an attestation server.

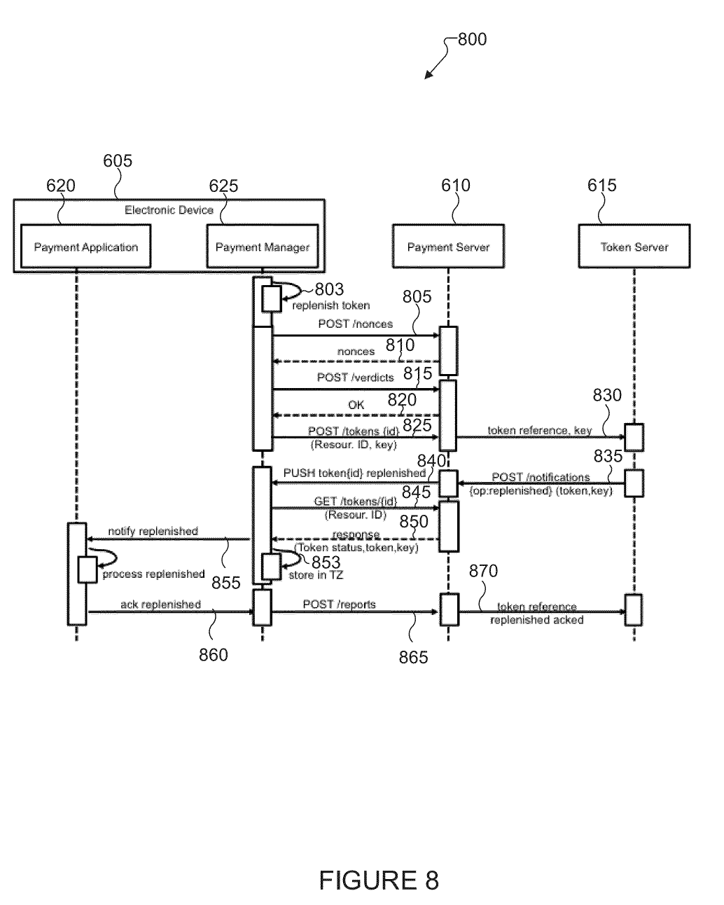

FIG. 8 illustrates a flow diagram 800 of a token update operation based on token attestation in an electronic device 605 according to various embodiments. The embodiment of the flow diagram 800 shown in FIG. 8 is for illustration only. Other embodiments of the flow diagram 800 could be used without departing from the scope of this disclosure.

In FIG. 8, the solid line may include a request (e.g., request or call) command and the dotted line may include a response (e.g., response or return) command. According to an embodiment, the payment system may include an electronic device 605, a payment server 610, or a token server 615. The electronic device 605 may include, for example, a payment application 620 and/or a payment manager 625.

According to various embodiments, the payment manager 625 may update (replenish) a token (803). For example, the payment manager 625 may perform the token update as an internal operation of the payment manager 625. The token update may be performed based on a predetermined command (e.g., replenish token).

According to various embodiments, the payment manager 625 may perform token attestation associated with the token update. For example, the payment manager 625 may perform the token attestation to enable use of the token. The token attestation may be performed, for example, by an internal operation of the payment manager 625 or based on an external input (e.g., user input or external device input).

According to various embodiments, the payment manager 625 may transfer a command associated with the token attestation to the payment server 610 (805). The command associated with the token attestation may be performed using, for example, a predetermined command (e.g., POST/nonces). According to various embodiments, the payment server 610 may transfer a response (e.g., nonces) corresponding to the command associated with the token attestation to the payment manager 625 (810).

According to various embodiments, the payment manager 625 may transfer a result associated with the token attestation to the payment server 610 (815). The result associated with the token attestation may be performed using, for example, a predetermined command (e.g., POST/verdicts).

According to various embodiments, the payment server 610 may transfer a response (e.g., OK) corresponding to the result associated with the token attestation to the payment manager 625 (820). According to one embodiment, the payment manager 625 may perform the token update, based on the response corresponding to the result associated with the token attestation.

According to various embodiments, the payment manager 625 may perform the token update, based on the token attestation. For example, the payment manager 625 may request the payment server 610 to perform token update (825). The request associated with the token update may be made using a predetermined command (e.g., POST/tokens/{id}).

According to various embodiments, the POST/tokens/{id} may be used in an operation in which the payment manager 625 performs token update with respect to the token server 615. For example, the POST/tokens command may include at least one of a token ID or a key (e.g., token key) associated with the token ID when the command is transferred. Based on the token ID, the token server 615 may update the token. The payment server 610 may forward the token reference or key to the token server 615 (830) and receive a POST/notifications command including the token (835). The payment server 610 may send a PUSH token{id} command to the payment manager 625 (840) and receive a GET/tokens/{id} command in return (845). The payment manager 625 may receive, for example, a response corresponding to the POST/tokens/{id} from the payment server 610, and the response corresponding to the POST/tokens/{id} may include key information (850). Further, the POST/tokens command may include, for example, a resource ID. The resource ID may include an identifier of the registered (enrollment) resource, which may be configured in the form of Uniform Resource Locator (URL). Further, the resource ID may include, for example, reference information storing information related to a token ID or token reference, and may include an address at which the token ID or the token reference is stored in the payment server 610.

According to various embodiments, the payment server 610 may transfer the token state, the token, and the token use key to the payment manager 625. According to various embodiments, the payment manager 625 may transfer a notification or event associated with the key to the payment application 620 (855). For example, the payment manager 625 may use a predetermined command (e.g., notify replenished) in transferring the notification or event associated with the key to the payment application 620. According to various embodiments, the payment manager 625 may store, in a trust zone, the information (e.g., the key) received from the payment server 610 (853). The payment manager 625 may store, for example, the new token use key in a security application included in the electronic device 605.

According to various embodiments, the payment application 620 may transfer a notification corresponding to an event or notification associated with the key to the payment manager 625 (860). For example, the payment application 620 may transfer information (e.g., ack replenished) indicating that the event or notification associated with the key is performed, to the payment manager 625. The information indicating that the event or notification associated with the key is performed may include, for example, an acknowledgment type. The notification corresponding to the event or notification associated with the key may include, for example, the token update (replenishment), and the token update may indicate, for example, that the PAN included in the electronic device 605 has been changed into a state allowing the payment function. The new token use key may be used in, for example, completing the update of the key corresponding to the PAN.

According to various embodiments, the payment manager 625 may transfer the token update operation to the payment server 610 (865). For example, the payment manager 625 may transfer a report that the token updating operation is performed, to the payment server 610, using a predetermined command (e.g., POST/reports). The payment manager 625 may transfer, for example, a report that the PAN has been changed into a state allowing execution of the payment function. According to an embodiment, the payment manager 625 may perform state synchronization with the payment server 610. According to various embodiments, the payment server 610 may transfer the token update operation to the token server 615 (870). For example, the payment server 610 may transmit a response (e.g., acknowledgement or token reference replenished) to the token server 615.

FIGS. 6-8 illustrate examples of flow diagrams for electronic device attestation. FIGS. 6-8 discuss the use of a payment server 610 and a token server 615. In one or more embodiments of this disclosure, the payment server 610 can be one example of a proxy server. In one example, payment server 610 could be VPN server 425 in FIG. 5, a VPN client 420, an attestation server 430, or a combination thereof. Token server 615 could be one example of an application server, such as application server 535 in FIG. 5. Additionally, various changes could be made, such as, for example, while shown as a series of steps, various steps in each figure could overlap, occur in parallel, occur in a different order, occur multiple times, or not be performed in one or more embodiments.

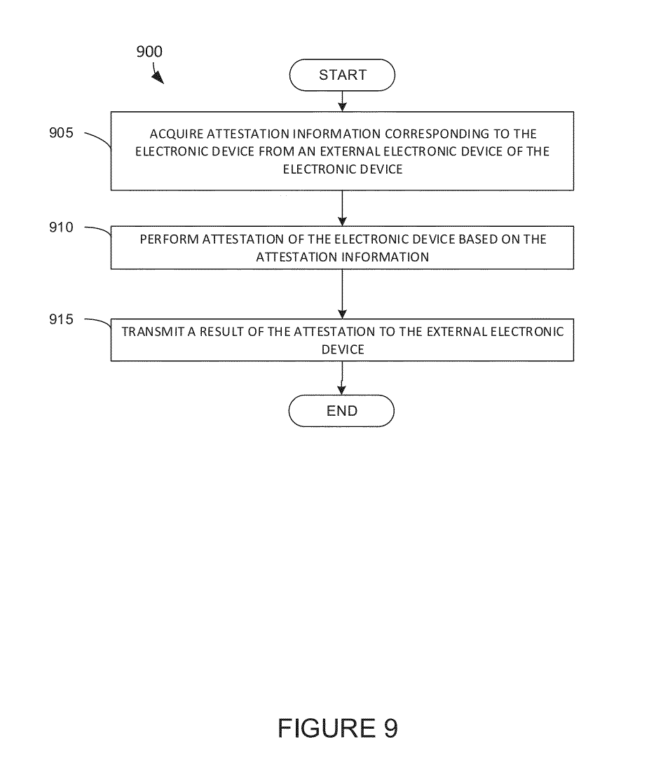

FIG. 9 illustrates a process 900 for attestation by an electronic device 605 in accordance with various embodiments of the present disclosure. For example, the process 900 depicted in FIG. 9 may be performed by the electronic device 300 in FIG. 3. The embodiment of the process 900 shown in FIG. 9 is for illustration only. Other embodiments of the process 900 could be used without departing from the scope of this disclosure.

Referring to FIG. 9, in operation 905, the electronic device 605 (e.g., terminal or portable phone) may acquire, for example, attestation information corresponding to the electronic device 605 from an external electronic device of the electronic device 605. According to an embodiment, in operation 905, the electronic device 605 may acquire the attestation information (also referred to as device data) as a request for the determination of the integrity of the electronic device 605. The attestation information may include, for example, a disposable random number (nonce).

In operation 910, the electronic device 605 may perform, for example, attestation of the electronic device 605, based on the attestation information. The attestation may include functions of identifying the security of the electronic device 605. The attestation may include functions of identifying the integrity of the electronic device 605.

In operation 915, the electronic device 605 may transmit, for example, a result of the attestation to the external electronic device or another electronic device 605. For example, the result (e.g., blob or security) of the attestation may be determined or generated based on the disposable random number (nonce) and/or the security information included in the electronic device 605. The other electronic device 605 may include, for example, a token server 615, a third party server, a wearable device, or a cloud server. The cloud server may include, for example, a personal cloud or a public cloud.

Although FIG. 9 illustrates examples of processes for attestation, various changes could be made to FIG. 9. For example, while shown as a series of steps, various steps in each figure could overlap, occur in parallel, occur in a different order, occur multiple times, or not be performed in one or more embodiments.

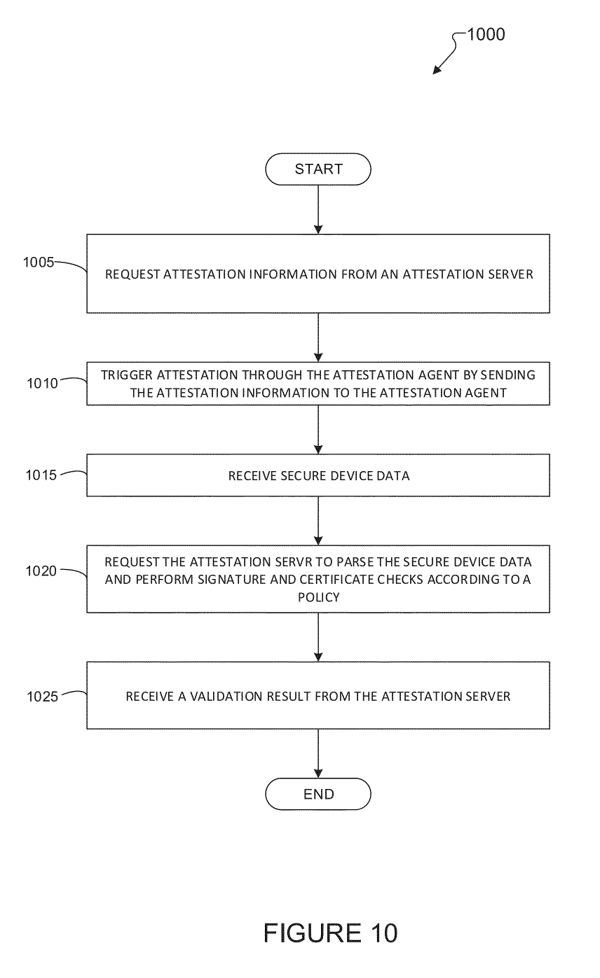

FIG. 10 illustrates a process 1000 for attestation by proxy server in accordance with various embodiments of the present disclosure. For example, the process 1000 depicted in FIG. 10 may be performed by the server 200 in FIG. 2. The embodiment of the process 1000 shown in FIG. 10 is for illustration only. Other embodiments of the process 1000 could be used without departing from the scope of this disclosure.

Referring to FIG. 10, in operation 1005, the proxy server (e.g., a VPN server) may request attestation information from an attestation server 430. According to an embodiment, in operation 1005, the proxy server may acquire the attestation information as a request for the determination of the integrity of the electronic device 505. The attestation information may include, for example, a disposable random number (nonce).

In operation 1010, the proxy server may trigger attestation though the attestation agent 415 by sending the attestation information to the attestation agent 415. The attestation agent 415 may use the attestation information to request a measurement from the trust zone 410. The trust zone 410 returns secure device data (e.g., in the form of a BLOB) to the attestation agent 415.

In operation 1015, the proxy server receives the secure device data. In operation 1020, the proxy server requests the attestation server 430 to parse the secure device data and perform signature and certificate checks, according to policy 540. In operation 1025, the proxy server receives a validation result from the attestation server 430. When the validation result is that the electronic device is to be trusted, the proxy server can notify the application server 535 to trust the electronic device 505. Or the proxy server can have the validation result formatted and/or data content updated in accordance with policy 540, and send the formatted and/or updated validation result to the application server.

Although FIG. 10 illustrates examples of processes for attestation, various changes could be made to FIG. 10. For example, while shown as a series of steps, various steps in each figure could overlap, occur in parallel, occur in a different order, occur multiple times, or not be performed in one or more embodiments. Although the present disclosure has been described with an exemplary embodiment, various changes and modifications may be suggested to one skilled in the art. It is intended that the present disclosure encompass such changes and modifications as fall within the scope of the appended claims.

None of the description in this application should be read as implying that any particular element, step, or function is an essential element that must be included in the claim scope. The scope of patented subject matter is defined only by the claims. Moreover, none of the claims is intended to invoke 35 U.S.C. §112(f) unless the exact words “means for” are followed by a participle.

What is claimed is:

1. A method for attestation by proxy, the method comprising:
retrieving, by an electronic device, secure device data of the electronic device;
performing, by the electronic device, attestation with an attestation server using a proxy server, wherein a validation result of the electronic device is generated based on the secure device data; and
communicating payment information with an application server when the validation result is trusted.

2. The method of claim 1, wherein a policy associated with the application server is obtained by the proxy server, and wherein the policy indicates validation logic specific to the application server and indicates a data format of the validation result that is acceptable by the application server.

3. The method of claim 1, wherein the proxy server comprises a virtual private network (VPN) server, further comprising:
establishing a secure connection with the VPN server using a VPN client.

4. The method of claim 2, wherein the policy is obtained from one of the application server or a default policy.

5. The method of claim 1, wherein performing, by the electronic device, attestation with the attestation server using the proxy server comprises:
requesting and receiving a nonce from the attestation server through the proxy server;
generating secure device data using the nonce and device measurements of the electronic device;
transmitting the secure device data to the attestation server through the proxy server.

6. The method of claim 5, wherein the secure device data is a binary large object generated using the nonce received from the attestation server and device measurements of the electronic device.

7. The method of claim 1, wherein communicating the payment information with the application server comprises:
receiving a token for use in a payment from the application server through the proxy server.

8. An electronic device for performing attestation by proxy, the electronic device comprising:
at least one processor configured to:
retrieve, by the electronic device, secure device data of the electronic device;
perform attestation with an attestation server using a proxy server, wherein a validation result of the electronic device is generated based on the secure device data; and
communicate payment information with an application server when the validation result is trusted.

9. The electronic device of claim 8, wherein a policy associated with the application server, wherein the policy indicates validation logic specific to the application server and indicates a data format of the validation result that is acceptable by the application server.

10. The electronic device of claim 8, wherein the proxy server comprises a virtual private network (VNP) server, wherein the at least one processor is further configured to:
establish a secure connection with the VPN server using a VPN client.

11. The electronic device of claim 9, wherein the policy is obtained from one of the application server or a default policy.

12. The electronic device of claim 8, wherein performing attestation with the attestation server using the proxy server comprises the at least one processor further configured to:
request and receive a nonce from the attestation server through the proxy server;
generate secure device data using the nonce and device measurements of the electronic device;
transmit the secure device data to the attestation server through the proxy server.

13. The electronic device of claim 12, wherein the secure device data is a binary large object generated using the nonce received from the attestation server and device measurements of the electronic device.

14. The electronic device of claim 8, wherein communicating the payment information with the application server comprises the at least one processor further configured to:
receive a token for use in a payment from the application server through the proxy server.

15. A non-transitory computer readable medium containing computer readable program code that, when executed, causes at least one processing device of an electronic device to:
retrieve secure device data of the electronic device;
perform attestation with an attestation server using a proxy server, wherein a validation result of the electronic device is generated based on the secure device data; and
communicate payment information with an application server us when the validation result is trusted.

16. The non-transitory computer readable medium of claim 15, wherein a policy associated with the application server is obtained by the proxy server, wherein the policy indicates validation logic specific to the application server and indicates a data format of the validation result that is acceptable by the application server.

17. The non-transitory computer readable medium of claim 15, wherein the proxy server comprises a virtual private network (VNP) server, wherein the computer readable program code that, when executed, causes at least one processing device of the mobile device further to:
establish a secure connection with the VPN server using a VPN client.

18. The non-transitory computer readable medium of claim 16, wherein the policy is obtained from one of the application server or a default policy.

19. The non-transitory computer readable medium of claim 15, wherein performing attestation with the attestation server using the proxy server further comprises the computer readable program code that, when executed, causes at least one processing device of the mobile device further to:
request and receive a nonce from the attestation server through the proxy server;
generate secure device data using the nonce and device measurements of the electronic device;
transmit the secure device data to the attestation server through the proxy server.

20. The non-transitory computer readable medium of claim 19, wherein the secure device data is a binary large object generated using the nonce received from the attestation server and device measurements of the electronic device.
